(19) United States
(12) Patent Application Publication
(10) Pub. No.: US 2026/0134870 A1
(43) Pub. Date: May 14, 2026

(54) METHOD AND SYSTEM FOR SPEECH TRANSCRIPTION

(71) Applicant: AIOLA LTD., Herzliya (IL)

(72) Inventors: Joseph KESHET, Tel Aviv (IL); Gill HETZ, Beit Lehem HaGlilit (IL); Aviv NAVON, Alonei Abba (IL); Aviv SHAMSIAN, Holon (IL); Yael SEGAL, Ofra (IL)

(73) Assignee: AIOLA LTD., Herzliya (IL)

(21) Appl. No.: 19/383,984

(22) Filed: Nov. 10, 2025

Related U.S. Application Data
(60) Provisional application No. 63/718,679, filed on Nov. 10, 2024.

(51) Int. Cl. G10L 15/26; G10L 15/06; G10L 25/30

(52) U.S. Cl. CPC G10L 15/26; G10L 15/063; G10L 25/30

(57) ABSTRACT

A system and method of speech transcription may include applying a machine-learning (ML) based encoder module to an audio data element representing a recording of speech, to obtain one or more encoding vectors, representing said recording in an audio encoding space. Embodiments of the invention may include performing an iterative transcription process on the one or more encoding vectors, to generate a token sequence representing a transcription of the recording. In each iteration, an ML-based multilayered decoder may be inferred on (i) the one or more encoding vectors and (ii) a current version of the token sequence, to a candidate token set that includes two or more candidate tokens, each representing a transcription of a respective word in the recording. The two or more candidate tokens may be appended to the current version of the token sequence, thereby updating the token sequence for a subsequent iteration.

### CROSS-REFERENCE TO RELATED APPLICATIONS

This application claims the benefit of priority of U.S. Patent Application No. 63/718,679, filed Nov. 10, 2024, which is hereby incorporated by reference.

### FIELD OF THE INVENTION

The present invention relates generally to the field of natural language processing. More specifically, the present invention relates to methods and systems for speech transcription.

### BACKGROUND OF THE INVENTION

Models for converting spoken language into text have evolved significantly, leveraging advanced techniques to process audio input. Traditional models often rely on architectures that process audio input through multiple stages. These models typically predict one unit at a time, resulting in slower processing speeds, especially for large datasets or complex speech patterns.

Existing solutions have attempted to address these speed limitations through various optimization strategies. Techniques such as model optimization, efficient hardware utilization, and algorithmic improvements have been explored.

Despite these efforts, the challenge of balancing speed and accuracy remains. Current models often face trade-offs, where improvements in speed can lead to a degradation in processing accuracy. This ongoing issue highlights the need for innovative approaches that can enhance the efficiency of these systems without compromising their performance.

### SUMMARY OF THE INVENTION

Some commercially available speech transcription and translation models, such as the popular “Whisper” model may be based on an attention-based, encoder-decoder machine-learning (ML) architecture. Such models may process audio by encoding it into encoded representations, and then decoding these representations into text, predicting one token at a time.

Due to their large size (e.g., approximately 1.5 billion parameters in the case of Whisper), these models typically face speed challenges. Embodiments of the invention may build upon currently available, or customary ML-based models to improve speed while maintaining token prediction accuracy.

As elaborated herein, embodiments of the invention may predict multiple tokens in parallel during each iteration, using a technique called Speculative Decoding. This technique involves generating multiple candidate tokens in each iteration, and subsequently selecting the most promising ones. This may be achieved by employing multiple “decision heads” as part of, or in conjunction with a final decoding layer of the transcription (e.g., Whisper) model, where each decision head may be assigned to predict one additional token. The inventors have experimentally exhibited significant improvement in speed, in relation to corresponding, currently-available, single-head transcription model implementations, while substantially maintaining an equivalent Word Error Rate (WER). This improvement is particularly beneficial for longer target sequences, where the speedup is more pronounced.

This improvement has been consistently demonstrated across various sequence lengths, providing a promising solution for robustly, and repetitively optimizing state-of-the-art computational methods of speech transcription.

The demonstrated parallel processing capability may allow embodiments of the invention to handle complex and varied speech patterns with reduced computational overhead, in relation to currently available solutions.

As elaborated herein, the term “Speculative Decoding” may refer to a technique used by embodiments of the invention, that involves generating multiple potential, or candidate tokens as output, and selecting the most promising ones therefrom. This approach may optimize the overall efficiency and effectiveness of the decoding process.

Embodiments of the invention may include a method of speech transcription by at least one processor. Embodiments of the method may include receiving an audio data element, representing a recording of speech; applying a machine-learning (ML) based encoder module on the audio data element, to obtain one or more encoding vectors, representing said recording in an audio encoding space; and performing an iterative transcription process on the one or more encoding vectors, to generate a token sequence representing a transcription of the recording.

Each iteration of the iterative transcription process may include obtaining a current version of the token sequence; inferring an ML-based multilayered decoder on (i) the one or more encoding vectors and (ii) the current version of the token sequence, to produce a first decoding vector, representing the audio data element in a latent transcription token space; based on the first decoding vector, predicting a candidate token set may include a plurality of K candidate tokens, each representing a transcription of a respective word in the recording; and appending two or more candidate tokens of the candidate token set to the current version of the token sequence, thereby updating the token sequence for a subsequent iteration.

Embodiments of the invention may further include, for each candidate token of the candidate token set, evaluating a confidence score, representing a probability of that candidate token correctly representing a transcription of the respective word; and choosing the two or more candidate tokens from the plurality of K tokens, based on the evaluated confidence scores.

Embodiments of the invention may further include obtaining an ML-based projection module, configured to: given an incident decoding vector, calculate a plurality of token probabilities, each representing a probability of utterance of a corresponding word in the speech recording; and select a candidate token based on the calculated plurality of token probabilities.

The ML-based multilayered decoder may include a serially-ordered stack of first decoding blocks. Embodiments of the invention may further include obtaining the first decoding vector from a final decoding block of the stack of first decoding blocks; and inferring the ML-based projection module on the first decoding vector, to select a first candidate token of the plurality of K candidate tokens.

Embodiments of the invention may further include applying (K−1) parallel ML-based heads on the first decoding vector, to obtain (K−1) corresponding latent vectors; and inferring the ML-based projection module on each of the (K−1) latent vectors, to select (K−1) corresponding, second candidate tokens of the plurality of K candidate tokens. The first candidate token and the (K−1) second candidate tokens may be selected within a single iteration of the iterative transcription process.

Embodiments of the invention may further include receiving a first training dataset, that includes one or more first encoding vectors, representing a first recording of speech in the audio encoding space; receiving one or more first token labels, each associating a specific encoding vector of the first training dataset with at least one corresponding word in the first recording of speech; and using the one or more first token labels as supervisory data, to train the ML-based multilayered decoder and the ML-based projection module, so as to select individual candidate tokens, based on corresponding first encoding vectors of the first training dataset.

Embodiments of the invention may further include receiving a second training dataset, may include one or more second encoding vectors representing a second recording of speech in the audio encoding space; inferring the ML-based multilayered decoder and the ML-based projection module on the one or more second encoding vectors, to obtain a sequence of annotation tokens, representing transcription of the second recording; and using the sequence of annotation tokens as self-supervisory data, to train at least one head of the (K−1) parallel ML-based heads, so as to generate latent vectors that pertain to at least one second token of the (K−1) second tokens, based on the one or more second encoding vectors.

Embodiments of the invention may further include inferring the multilayered decoder on (i) the one or more encoding vectors and (ii) a first subset of the token sequence, to generate one or more first latent vectors of one or more respective, first tokens of the candidate token set; based on the one or more first latent vectors, calculating a first plurality of token probabilities, representing probability of appearance of respective words in the speech recording; inferring the multilayered decoder on (i) the one or more encoding vectors and (ii) a second subset of the token sequence, to generate one or more second latent vectors of one or more respective, second tokens of the candidate token set; based on the one or more second latent vectors, calculating a second plurality of token probabilities, representing probability of appearance of respective words in the speech recording; and adjusting the token sequence based on the first and second pluralities of token probabilities.

Embodiments of the invention may include a system for speech transcription. Embodiments of the system may include a non-transitory memory device, where modules of instruction code may be stored, and at least one processor associated with the memory device, and configured to execute the modules of instruction code.

Upon execution of said modules of instruction code, the at least one processor may be configured to receive an audio data element, representing a recording of speech; apply an ML based encoder module on the audio data element, to obtain one or more encoding vectors, representing said recording in an audio encoding space; and perform an iterative transcription process on the one or more encoding vectors, to generate a token sequence representing a transcription of the recording.

At each iteration of the iterative transcription process, the at least one processor may be further configured to obtain a current version of the token sequence; inferring an ML-based multilayered decoder on (i) the one or more encoding vectors and (ii) the current version of the token sequence, to produce a first decoding vector, representing the audio data element in a latent transcription token space; based on the first decoding vector, predict a candidate token set may include a plurality of K candidate tokens, each representing a transcription of a respective word in the recording; and append two or more candidate tokens of the candidate token set to the current version of the token sequence, thereby updating the token sequence for a subsequent iteration.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for speech transcription, according to some embodiments;

FIG. 2 is a block diagram depicting an attention-based transformer model, adapted to perform speech transcription, as known in the art;

FIGS. 3A-3C are schematic diagrams showing the function of an attention-based transformer model, adapted to perform speech transcription, as known in the art;

FIG. 4 is a block diagram depicting an example of a system for speech transcription, which may include an attention-based transformer model, adapted to transcribe incoming audio data according to some embodiments of the invention;

FIGS. 5A-5C are schematic diagrams showing the function of an attention-based transformer model, adapted to perform speech transcription, according to some embodiments of the invention;

FIG. 6 is a block diagram depicting another example of a system for speech transcription, which may include an attention-based transformer model, adapted to transcribe incoming audio data according to some embodiments of the invention;

FIG. 7 is a flow diagram, depicting a method of transcribing speech, according to some embodiments of the invention; and

FIG. 8 is a chart, showing speedup of a process of speech transcription by embodiments of the invention, as a function of sentence length.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

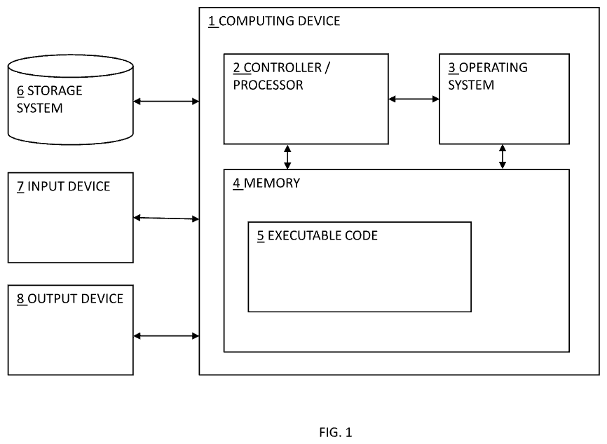

Reference is now made to FIG. 1, which is a block diagram depicting a computing device, which may be included within an embodiment of a system for transcribing speech, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may transcribe speech as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Audio data that represents human speech may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

The term neural network (NN) or artificial neural network (ANN), e.g., a neural network implementing a machine learning (ML) or artificial intelligence (AI) function, may be used herein to refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. At least one processor (e.g., processor 2 of FIG. 1) such as one or more CPUs or graphics processing units (GPUs), or a dedicated hardware device may perform the relevant calculations.

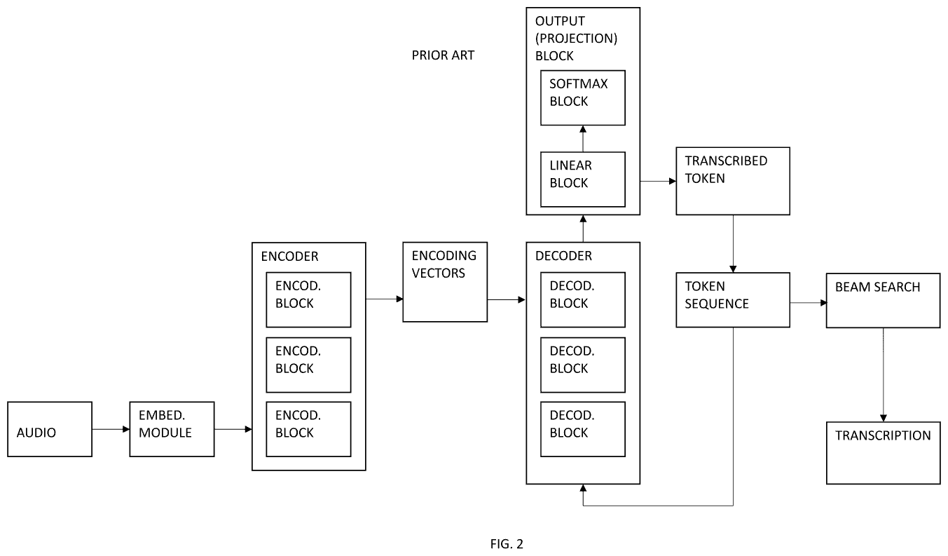

Reference is now made to FIG. 2, which is a block diagram depicting a machine-learning (ML) based transformer for audio transcription, as known in the art.

As shown in FIG. 2, an audio component of the transformer may receive an audio data element representing a recording of speech. This component serves as the initial input interface for the system, capturing raw audio data that will undergo subsequent processing.

The audio data element may then be forwarded to an embedding module, which may process the audio data element to generate an audio embedding. This module typically utilizes machine learning techniques to transform the raw audio data into a high-dimensional vector representation, which captures the features of the audio signal. The embedding module may output these vectors to an encoder.

The encoder may receive the audio embedding from the embedding module and apply a series of encoding blocks to the audio embedding. Each encoding block may process the input vectors through a series of transformations, typically involving linear layers, normalization, and activation functions. The encoder may convert the audio embedding into a set of encoding vectors that may represent the audio data in a more abstract and compact form. These encoding vectors may then be passed to an attention-based decoder.

The attention-based decoder may receive the encoding vectors from the encoder. The decoder may also receive a current version of a token sequence, which represents an ad-hoc transcription of the original audio data element. The decodes may process this input through a series of decoding blocks, to generate a latent vector representing the audio data element in a textual token space. As known in the art, this latent representation vector may typically be in the order of 1000 entries.

The latent vector may then be used for further processing in an output module, also referred to herein as a projection module. The projection module may receive the latent vector from the decoder and apply a linear transformation, followed by a SoftMax function on this data.

The linear transformation may involve multiplying the input vector by a weight matrix and adding a bias term, resulting in projection of the latent vector to the space of tokens. As each token may represent an utterance (e.g., a word, or sub-word), the space of tokens may be quite large (e.g., in the order of 50,000), corresponding to the number of available words and sub-words for transcription. The SoftMax function is adapted to convert the output of the linear transformation, to generate a distribution of probabilities of the possible transcription tokens, as representing genuine transcription of the incoming audio.

The calculated probabilities may represent likelihood of each possible transcription token as a correct transcription of a word in the audio recording. The SoftMax function module may be configured to ensure that a sum of the output probabilities is equal to one, allowing selection of a single, most likely transcription token in each iteration. The projection module may thereby select, in each iteration, a single candidate token based on the calculated probabilities, and append the selected token to an evolving token sequence.

The token sequence is a dynamically evolving list that may accumulate the transcribed tokens generated by the projection module. This sequence may represent an evolving transcription of the original audio data element.

In currently available systems, the token sequence is updated iteratively, with a single new transcribed token being appended to the current sequence at each iteration. This updated sequence is then used by the decoder as additional input for the next iteration of the transcription process.

As elaborated herein, embodiments of the invention may build upon the properties of the attention-based decoder of FIG. 2, to produce, in each iteration, a plurality of candidate tokens, corresponding to a sequence of spoken words or utterances in the recorded audio. In other words, at each iteration, embodiments of the invention may append a plurality of words (rather than a single word) to the outcome transcribed sequence, thereby improving the iterative transcription process known in the art.

Furthermore, embodiments of the invention may facilitate generation of the plurality of tokens at each iteration, instead of generating a single token, without significantly increasing consumption of computational (e.g., processing and memory) resources.

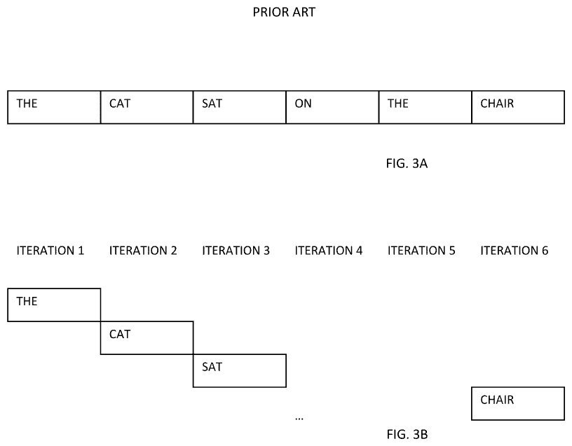

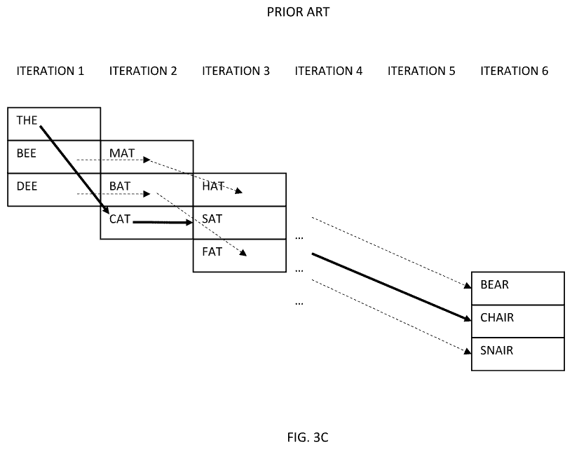

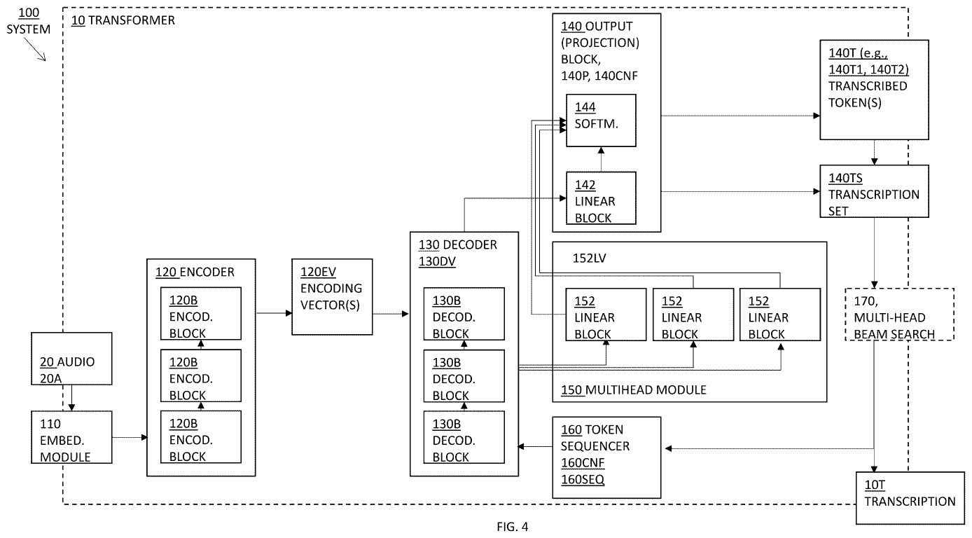

Reference is now made to FIGS. 3A-3C, which are schematic diagrams showing an example for operation of an attention-based transformer model, adapted to perform speech transcription, as known in the art.

FIG. 3A depicts an input audio stream. In this example, the audio stream includes an utterance of the sentence “The cat sat on the chair”.

FIG. 3B depicts a process in which the transformer produces, in each iteration, a single token that represents a transcription of a corresponding word in the uttered sentence. On one hand, the produced token is appended onto the evolving token sequence, and driven into the decoder, to assist in decoding a subsequent token. On the other hand, the produced token is used as part of the evolving token sequence, to ultimately generate the required transcribed sentence.

As known in the art, a beam search algorithm is a method used in tasks such as speech recognition, machine translation, and text generation, for determining the most likely sequence of tokens. Unlike a greedy search algorithm, where only a token having the highest probability is selected at each step, a beam search algorithm keeps track of the top K tokens at every step, thereby expanding the search space.

FIG. 3C depicts a process in which a transformer applies a beam search algorithm, to produce the required, transcribed sentence.

In the example of FIGS. 3A-3C, a transformer model may receive an audio stream including the sentence “The cat sat on a chair”. Without using a beam search algorithm, the transformer model might incorrectly predict “fat” or “hat” after “cat” because of a noisy input. However, when utilizing a beam search algorithm, the transformer model will not commit to the first prediction. Instead, it may keep multiple options (e.g., “sat,” “fat,” “hat”) and evaluates which one fits best as more tokens are decoded.

In this example, instead of choosing just one token with the highest probability, the transformer may retain the K (in this example: 3) candidates (also referred to as “hypotheses”. In this example, the first 3 candidates having the highest probabilities, that are selected in the first iteration may be “THE”, “BEE”, and “DEE”.

For each of these K tokens, the transformer model may subsequently predict the next possible candidate tokens (“MAT”, “BAT”, “CAT”), forming K×K (e.g., :9) combinations. From these, the transformer model may select the top K (e.g., 3) sequences based on their overall likelihood. In the example of FIG. 3C, these sequences include [THE, CAT], [BEE, MAT], and [DEE, BAT].

At a final stage of the transcription process, once the entire input (e.g., the audio file or stream) has been processed, the beam search algorithm may select the sequence that is most probable over all sequences, as a final output. This selection is depicted by the bold arrows in FIG. 3C.

FIG. 4 is a block diagram depicting an example of a system for speech transcription, which may include an attention-based transformer model, adapted to transcribe incoming audio data according to some embodiments of the invention;

Reference is now made to FIG. 4, which depicts a system 100 for transcribing audio speech, according to embodiments of the present invention.

According to some embodiments of the invention, system 100 may be implemented as a software module, a hardware module, or any combination thereof. For example, system may be or may include a computing device such as element 1 of FIG. 1, and may be adapted to execute one or more modules of executable code (e.g., element 5 of FIG. 1) to transcribe audio speech, as further described herein.

As shown in FIG. 4, arrows may represent flow of one or more data elements to and from system 100 and/or among modules or elements of system 100. Some arrows have been omitted from FIG. 4 for the purpose of clarity.

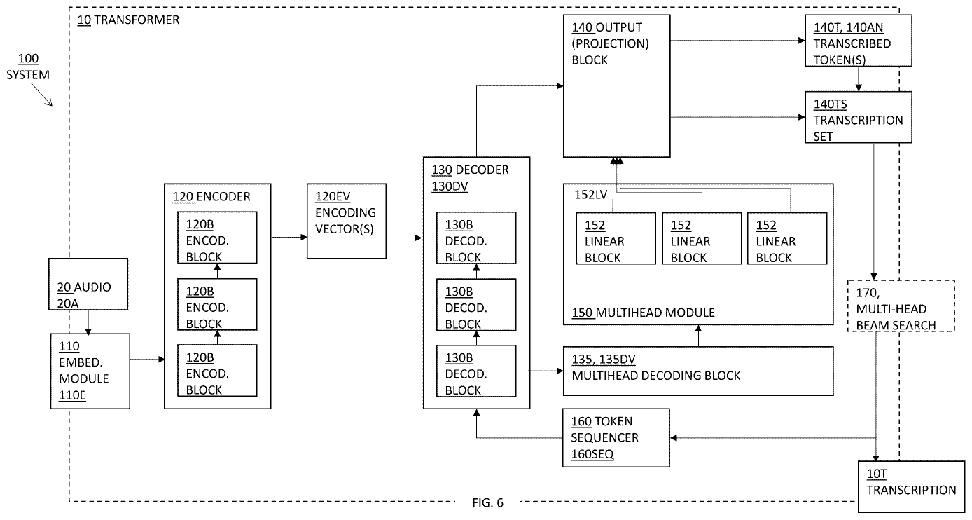

According to some embodiments, system 100 may be, or may include an attention-based transformer 10, adapted to produce efficient transcription of incoming audio data 20A (e.g., an audio stream), As elaborated herein (e.g., in relation to FIGS. 4 and 6), transformer 10 may build upon prior art architecture (e.g., as depicted in FIG. 2), by introducing a multi-head module 150, which may facilitate generation of a plurality of candidate tokens in each iteration of the transcription process.

System 100 may receive an audio data element 20A representing a recording of speech, that may undergo subsequent processing, as elaborated herein. Additionally, or alternatively, system 100 may include an audio capturing or reproduction element 20 such as a microphone, a recorder, a music player, and the like, adapted to generate or reproduce an audio data element such as an audio file or stream 20A, that may include recorded speech.

As elaborated herein (e.g., in relation to FIG. 2), transformer 10 may include an embedding module 110, adapted to processes audio data element 20A, to generate an audio embedding 110E. Embedding module 110 may utilize machine learning (ML) techniques to transform audio data 20A into a high-dimensional audio embedding vector 110E representation, capturing the features of the incoming audio signal. Embedding module 110 may output embedding vector 110E to a multilayered, ML-based encoder module 120.

Encoder module 120 may receive audio embedding vector(s) 110E from embedding module 110, and apply a series of encoding blocks 120B to the audio embedding 110E. Each encoding block 120B may process the input vectors through a series of transformations, typically involving linear layers, normalization, and activation functions. Encoder 120 may thus convert audio embedding vector(s) 110E into a set of encoding vectors 120EV that may represent the audio data 20A in an abstract and compact form.

In other words, Transformer 10 may apply encoder module 120 on the audio data element 20A (e.g., on the embedding vector 110E representation thereof), to obtain one or more encoding vectors 120EV, representing the recording in an audio encoding space.

As elaborated herein, transformer 10 may proceed to perform an iterative transcription process on the one or more encoding vectors 120EV, to generate a token sequence 160SEQ representing a transcription of the recording in audio data element 20A.

Token sequence 160SEQ may initially include a special “Start of Sentence (SoS)” token. As shown in FIG. 4, transformer 10 may include an ML-based multilayered decoder module 130. In each iteration of the iterative transcription process, transformer 10 may infer ML-based multilayered decoder 130 on (i) the one or more encoding vectors 120EV and (ii) the current version of the token sequence 160SEQ, to produce at least one (e.g., a plurality of) decoding vector 130DV, representing the audio data element 20A in a latent transcription token space.

Decoder 130 may receive encoding vectors 120EV from the encoder, and the current version of token sequence 160SEQ, and processes these input through a series of decoding blocks 130B to generate decoding vector 130DV. Decoding vector 130DV may then be used for further processing in an ML-based projection module 140.

Projection module 140 may receive decoding vector 130DV from decoder 130, and apply a linear transformation block 142 followed by a SoftMax function 144. The linear block 142 performs a weighted sum of the input features, while the SoftMax block may convert these weighted sums into probabilities. These probabilities may represent the likelihood of each possible transcription token. Projection module 140 may thereby generate a transcribed token 140T (e.g., 140T1) based on the probability, in a similar manner as that elaborated herein (e.g., in relation to FIG. 2), and append token 140T (e.g., 140T1) to token sequence 160SEQ.

During a training stage, system 100 may receive a training dataset that may include a plurality of annotated decoding vectors 130DV. These decoding vectors 130DV may be annotated in a sense that they may include, or be associated with respective annotations or labels, which may indicate a corresponding, ground truth token 140T. As known in the art, system 100 may subsequently utilize a training scheme (e.g., a backward propagation scheme), to train components (e.g., linear block 142, SoftMax block 144) of projection module 140, so as to predict a token 140T, using the labels or annotations as supervisory information.

In a subsequent, inference stage, pretrained projection module 140 may be given an incident decoding vector 130DV (e.g., from decoder 130). Projection module 140 may utilize pretrained linear block 142 and SoftMax block 144 to calculate a plurality of token probabilities 140P, each representing a probability of utterance of a corresponding word in the speech recording of audio 20A. Projection module 140 may select a candidate token 140T based on the calculated plurality of token probabilities.

Additionally, or alternatively, based on the training, projection module 140 may produce a confidence value 140CNF that may represent a confidence of projection module 140 in selecting candidate token 140T.

It may be appreciated that the training stage of projection module 140 may precede a subsequent inference of pretrained projection module 140 on decoding vectors 130DV (originating from audio 20A). Additionally, or alternatively, the training and inference stages of projection module 140 may be intermittent, allowing system 100 to refine the training of projection module 140 over time.

As shown in FIG. 4, transformer 10 may include a multi-head module 150. multi-head module 150 may build upon an observation that decoding vector 130DV, adapted to collaborate with a projection module 140 to predict, based on the first decoding vector, a candidate token set, (also referred to as a transcription set) 140TS. Candidate token set 140TS may include a plurality (e.g., K) candidate tokens 140T, each representing a transcription of a respective word in the recording of audio data element 20A.

As elaborated herein, multi-head module 150 may facilitate the generation of the plurality of candidate tokens in each iteration of the transcription process, based on the inventors'observation that a decoding vector 130DV of a specific iteration typically holds information that may be predictive not just for the currently analyzed utterance (and the corresponding ad-hoc transcription sequence 160SEQ), but also for one or more subsequent utterances in audio data element 20A.

In other words, due to the structure of attention-based transformer 10, the current iteration may include “hints” for transcribing subsequent utterances in audio 20A. A naïve implementation for exploiting these “hints”, and concurrently predicting multiple tokens would require duplicating at least the projection module 140, resulting in significant increase memory consumption. Pertaining to the example provided above, given a typical 1,000 element long decoding vector 130DV, and a typical 50,000 wide selection of possible tokens 140T (each representing a unique transcription of an utterance or word), the additional number of required weights or parameters used by transformer 10 may be in the order of 50 Million. Instead, the inventors have observed that mere addition of properly trained, linear block instances 152, each having the same order of parameters (e.g., 1,000) as the decoding vector 130DV, may each predict (in collaboration with SoftMax module 144) one token of the candidate token set 140TS.

As shown in FIG. 4, multi-head module may include a plurality (K) of linear blocks 152, each of which adapted to processes decoding vector 130DV from decoder 130, to simultaneously (e.g., within the same iteration) generate (via SoftMax module 144) a respective plurality (K) of candidate tokens (i.e., candidate token set 140TS).

In the example provided in FIG. 4, the number (K) of linear blocks (142 and 152) is 4, facilitating a candidate token set 140TS that may include as many as K (4 or less) tokens 140T.

In other words, this parallel transcription process may allow system 100 to predict a candidate token set 140TS having a plurality of as many as K candidate tokens 140T in each iteration, based on decoding vector 130DV, where each candidate token represents a transcription of a respective word in the recording of audio 20A. System 100 may thereby significantly improve the efficiency and accuracy of the transcription process, in relation to currently available transcription systems, which may only produce a single token 140T per iteration.

According to some embodiments, and as shown in FIG. 4, transformer 10 may apply a first linear block 142 (and subsequently SoftMax block 144) on decoding vector 130DV, to predict a first token 140T (e.g., 140T1).

Transformer 10 may further apply one or more (e.g., (K−1)=3, in the example of FIG. 4) parallel ML-based heads, denoted herein as linear blocks 152, on decoding vector 130DV, to obtain one or more (e.g., (K−1)) corresponding latent vectors 152LV. Transformer 10 may subsequently infer the ML-based projection module 140 (e.g., infer SoftMax module 144 of projection module 140) on each of the one or more (e.g., (K−1)) latent vectors 152LV, to select one or more (e.g., (K−1)) corresponding, additional candidate tokens 140T (e.g., 140T2) of the plurality of K candidate tokens. As explained herein, the first candidate token 140T (e.g., 140T1) and the (K−1) second candidate tokens 140T (e.g., 140T2) may be selected within a single iteration of the iterative transcription process.

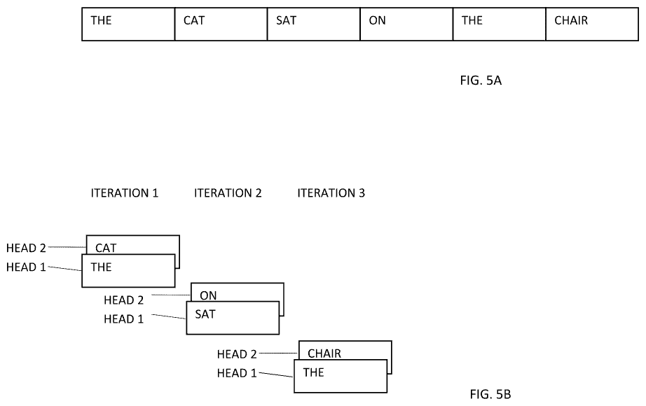

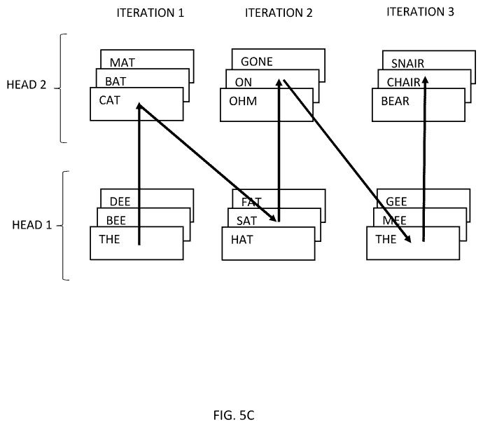

Reference is further made to FIGS. 5A-5C, which are schematic diagrams showing an example for operation of an attention-based transformer model 10 according to some embodiments of the invention.

FIG. 5A depicts an input stream, e.g., original audio data element 20A. Similar to the example of FIG. 3A, the audio stream or audio file 20A may include an utterance of the sentence “The cat sat on the chair”.

As elaborated herein, in contrast to currently available transformer architectures, which predict a single token at each step, the multi-head transformer 10 of the present invention may allow simultaneous (e.g., within a single iteration) prediction of multiple, sequential tokens 140T.

As shown in the example of FIG. 5B, at a first iteration, the linear blocks 152 of multi-head module 150 may generate respective latent vectors 152LV that correspond to (will be projected as) candidate tokens 140T “THE”, “CAT” and “SAT”. In a subsequent iteration, the linear blocks 152 of multi-head module 150 may generate respective latent vectors 152LV that will be projected as candidate tokens 140T “ON”, “THE” and “CHAIR”.

Embodiments of the invention may further improve performance (e.g., accuracy) of the transformer 10 by introducing a multi-head prediction beam search module 170, adapted to apply a multi-head prediction beam search algorithm on decoded, transcribed tokens 140T of the candidate token set 140TS.

As explained herein, in a standard beam search algorithm, all hypotheses must be of the same length at each step. Pertaining to the example of FIG. 3C: At the second iteration, K\hat{ }2 (e.g., 9) combinations are formed, of which K hypotheses are selected, each being 2 tokens long. At the third iteration K hypotheses are selected, each being 3 tokens long, and so forth.

In contrast, multi-head beam search module 170 may construct the top K hypotheses from the K sequences selected across the heads, without requiring that they should have the same lengths.

In other words, a regular, single-head beam search algorithm (e.g., as shown in FIG. 3C) may perform the decoding steps sequentially, with each step producing one token. As a result, all sequences in the beam must have the same length at any given step. However, this is not the case for multi-head prediction. In multi-head prediction (e.g., as illustrated in FIG. 5C), each decoding step can generate sequences of varying lengths, from two tokens to the number of heads. The beam search algorithm may subsequently select the K-best hypotheses, where each hypothesis may have a different length (different number of candidate tokens). This, in turn, may lead to subsequent decoding iterations where sequences of different lengths may be processed.

Pertaining to the example of FIG. 5C, at each iteration, transformer 10 may retain the top K (e.g., 3) tokens from each of the N (e.g., 2) heads, thereby creating a decoding tree that represents K\hat{ }N candidate combinations. In the example of FIG. 5C, at the first iteration the K\hat{ }N candidates include all possible combinations of [“THE”, “BEE” and “DEE”] with [“CAT”, “BAT”, and “MAT”].

Multi-head beam search module 170 may evaluate the decoding tree, to select the top K hypotheses from the K\hat{ }N candidates having the highest likelihood, as hypotheses for the next iteration, and may be introduced as token sequences 160SEQ into decoder 130.

For example, all predicted tokens may be passed through the base head (the original decoder's 130 prediction head 142) in a single pass. The tokens selected from the K heads may be those whose resulting probabilities, as output by the base head, exceed a predefined threshold.

Unlike standard the standard beam search algorithm (e.g., as depicted in FIG. 3C), the K selected hypotheses of multi-head beam search module 170 may vary in length due to the use of multiple heads.

As shown in FIG. 5C, the above actions may be repeated for subsequent iterations, until the entire input (e.g., audio file 20A) is processed. Once the input is fully processed, multi-head beam search module 170 may select the token sequence 160SEQ having the highest overall probability as the final output transcription 10T.

Reference is further made to FIG. 6, which is a block diagram depicting another example of system 100 for speech transcription, according to some embodiments of the invention.

As elaborated herein (e.g., in relation to FIG. 4), decoder 130 may include a serially-ordered stack of first decoding blocks 130B. Transformer 10 may produce a first decoding vector 130DV from a final decoding block 130B of the stack of first decoding blocks. Transformer 10 may subsequently: (a) infer the ML-based projection module 140 on the first decoding vector 130DV, to select a first candidate token 140T (e.g., 140T1) of the plurality of K candidate tokens in candidate token set 140TS; and (b) infer the SoftMax module of projection module 140 on the one or more (e.g., (K−1)) latent vectors 152LV, to select one or more second candidate tokens 140T (e.g., 140T2) of the plurality of K candidate tokens in candidate token set 140TS.

Additionally, or alternatively, and as shown in FIG. 6, transformer 10 may include a multi-head decoding block 135, which may be, or may include one or more decoding blocks, similar to decoding blocks 130B of decoder 130.

In such embodiments, transformer 10 may produce a first decoding vector 130DV from a final decoding block 130B of the stack of first decoding blocks of decoder 130. multi-head decoding block 135 may be configured to receive the first decoding vector 130DV and generate therefrom a second decoding vector 135DV. Transformer 10 may subsequently:
(a) infer the ML-based projection module 140 on the first decoding vector 130DV, to select a first candidate token 140T (e.g., 140T1) of the plurality of K candidate tokens in candidate token set 140TS;
(b) apply the one or more (e.g., (K−1)=3, in the example of FIG. 6) parallel ML-based heads, denoted herein as linear blocks 152, on decoding vector 135DV, to obtain one or more (e.g., (K−1)) corresponding latent vectors 152LV; and
(c) infer the SoftMax module of projection module 140 on the one or more (e.g., (K−1)) latent vectors 152LV, to select one or more (e.g., (K−1)=3) candidate tokens 140T (e.g., 140T2) of the plurality of K candidate tokens in candidate token set 140TS.

As shown in FIG. 4, transformer 10 may include a token sequencer 160, responsible for maintaining and updating the token sequence 160SEQ. As explained herein, token sequence 160SEQ may be a dynamic list that accumulates the transcribed tokens 140T generated by projection module 140. This sequence may represent the transcription of the original audio data element 20A. Token sequence 160SEQ may be updated iteratively, with each new candidate token set 140TS being appended to the current sequence 160SEQ.

In other words, at each iteration, token sequencer 160 may append two or more candidate tokens 140T of the candidate token set 140TS to the current version of the token sequence 160SEQ, thereby updating the token sequence 160SEQ as input for a subsequent iteration of the transcription process.

According to some embodiments, token sequencer 160 may, for each candidate token 140T of the candidate token set 140TS, evaluate a confidence score 160CNF, representing a probability of that candidate token 140T correctly representing a transcription of a respective utterance (e.g., spoken word) in the recording of audio data element 20A.

For example, token sequencer 160 may calculate confidence score 160CNF based on (e.g., equal to) the probability of candidate tokens 140T, as output by the base head 142 of decoder 130.

Additionally, or alternatively, token sequencer 160 may receive confidence score 140CNF from projection module 140, and utilize confidence score 140CNF as confidence score 160CNF, to select and append the two or more candidate tokens 140T of the candidate token set 140TS to the current version of the token sequence 160SEQ.

Token sequencer 160 may subsequently choose one, two or more candidate tokens from the plurality of K tokens, based on the evaluated confidence scores 160CNF. For example, token sequencer 160 may select only candidate tokens whose confidence score 160CNF surpasses a predetermined threshold.

According to some embodiments, decoder 130, projection module 140, multi-head module 150 and multi-head decoding block 135 may be trained in two separate, or intertwined phases.

In a first training phase, ML-based multilayered decoder 130 and the ML-based projection module 140 may be trained via a supervised training scheme, using a first, annotated dataset.

For example, during the first training phase, transformer 10 may receive (e.g., via input 7 of FIG. 1) the first training dataset, which may include one or more first encoding vectors 120EV, representing a first recording of speech in the audio encoding space. Transformer 10 may also receive (e.g., from input 7) one or more first token labels, each associating a specific encoding vector of the first training dataset with at least one corresponding word in the first recording of speech. Transformer 10 may use the one or more first token labels as supervisory data, to train the ML-based multilayered decoder 130 and the components of ML-based projection module 140, so as to select individual candidate tokens 140T, based on corresponding first encoding vectors 120EV of the first training dataset.

In a subsequent, or intertwined training phase, transformer 10 may employ a self-supervised training scheme to train at least one of the multi-head decoding block 135 and/or the linear block(s) of multi-head module 150.

For example, during the first training phase, transformer 10 may receive (e.g., via input 7 of FIG. 1) a second training dataset, that may include one or more second encoding vectors 120EV, representing a second recording of speech 20A in the audio encoding space.

Transformer 10 may infer the ML-based multilayered decoder 130 and the ML-based projection module 140 on the one or more second encoding vectors 120EV of the second training set, to automatically obtain a sequence of annotation tokens 140AN, representing transcription of the second recording.

Transformer 10 may subsequently use the sequence of annotation tokens as self-supervisory data, to train at least one head of the (K−1) parallel ML-based heads (e.g., linear blocks 152) and/or decoding block 135, so as to generate latent vectors 152LV that pertain to at least one second token 140T (e.g., 140T2) of the (K−1) tokens, based on the one or more encoding vectors 120EV of the second, non-annotated training dataset.

According to some embodiments, token sequencer 160 may facilitate detection, and even correction of errors in selecting candidate tokens 140T. This may be achieved by selection of different subsets of tokens 140T of the candidate token set 140TS, and calculation of likelihood of each subset as a genuine representative of transcribed utterances or words in audio 20A.

For example, transformer 10 may infer multilayered decoder 130 on (i) the one or more encoding vectors 120EV and (ii) a first subset of the token sequence 1, to generate one or more first latent vectors 152LV of one or more respective, first tokens 140T (e.g., 140T1) of the candidate token set.

Based on the one or more first latent vectors 152LV, transformer 10 may calculate a first plurality of token probabilities 140P, representing probability of appearance of respective words in the audio speech recording 20A.

transformer 10 may repeat this process with a second subset of the token sequence, to generate one or more second latent 152LV vectors of one or more respective, second tokens 140T (e.g., 140T2) of the candidate token set.

Based on the one or more second latent vectors 152LV, transformer 10 may calculate a second plurality of token probabilities 140P, representing probability of appearance of respective words in the audio speech recording 20A.

Transformer 10 may subsequently adjust the candidate token sequence 160SEQ based on the first and second pluralities of token probabilities 140P.

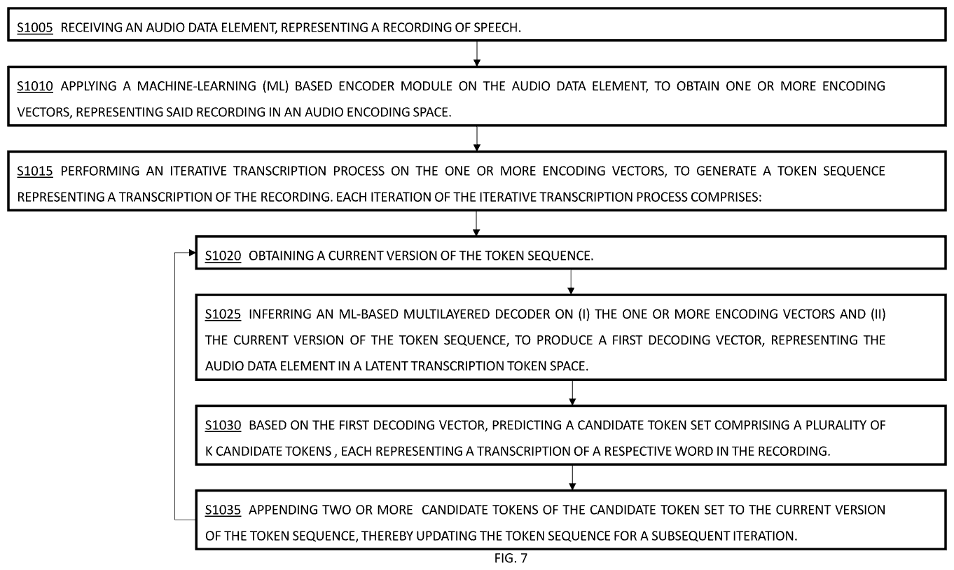

Reference is now made to FIG. 7, which is a flow diagram, depicting a method of transcribing speech by at least one processor (e.g., processor 2 of FIG. 1), according to some embodiments of the invention.

As shown in steps S1005 and S1010, the at least one processor 2 may receive an audio data element such as an audio file or stream (e.g., 20A of FIG. 4), representing a recording of speech. The at least one processor 2 may apply a machine-learning (ML) based encoder module (e.g., 120 of FIG. 4) on the audio data element, to obtain one or more encoding vectors (e.g., 120EV of FIG. 4), representing said recording in an audio encoding space.

As shown in step S1015, the at least one processor 2 may perform an iterative transcription process on the one or more encoding vectors, to generate a token sequence (e.g., 160SEQ, 10T of FIG. 4) representing a transcription of the recording.

As shown in FIG. 7, at each iteration of the iterative transcription process, the at least one processor 2 may perform the following steps S1012 through S1035:

As shown in steps S1020 and S1025, the at least one processor 2 may obtain a current version of the token sequence, and infer an ML-based multilayered decoder (e.g., 130 of FIG. 4) on (i) the one or more encoding vectors and (ii) the current version of the token sequence, to produce a first decoding vector (e.g., 130DV of FIG. 4), representing the audio data element 20A in a latent transcription token space.

As shown in steps S1020, based on the first decoding vector, the at least one processor 2 may predict a candidate token set (e.g., transcription set 140TS of FIG. 4), that may include a plurality of K candidate tokens. Each of the K candidate tokens may represent a transcription of a respective utterance or word in the recording 20A.

As shown in steps S1020, the at least one processor 2 may append two or more candidate tokens of the K candidate tokens in the candidate token set 140TS, to the current version of the token sequence 160SEQ, thereby updating the token sequence for a subsequent iteration.

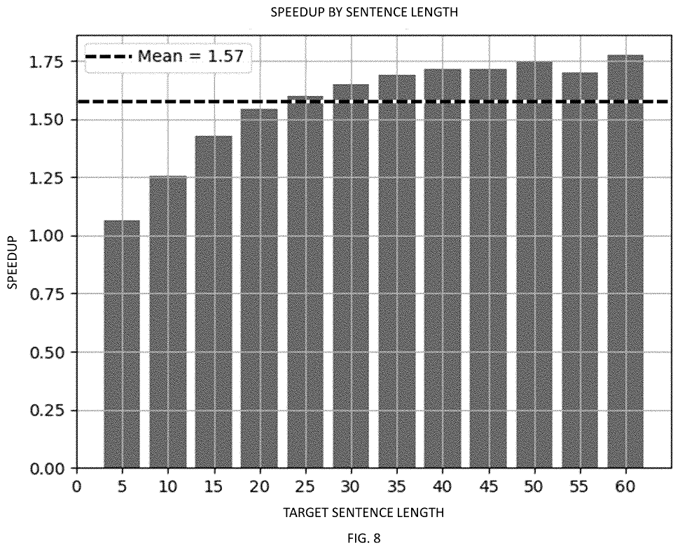

Reference is now made to FIG. 8, which is a chart, showing speedup of a process of speech transcription by embodiments of the invention, as a function of sentence length. The X-axis of the chart represents a length of target decoded sentences. The Y-axis of the chart represent a mean speedup (e.g., percentage of improved latency) in transcribing each spoken sentence by embodiments of the invention (e.g., system 100 as described in relation to FIGS. 4 and 6) in relation to a comparable, currently available transcription system (e.g., as described in relation to FIG. 2). It may be appreciated that system 100 outperforms the currently available solution in all categories of sentence length. It may also be noticed that this improvement increases asymptotically, as the sentences grow longer, up to sentence lengths of 40-50 words.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of speech transcription by at least one processor, the method comprising:
receiving an audio data element, representing a recording of speech;
applying a machine-learning (ML) based encoder module on the audio data element, to obtain one or more encoding vectors, representing said recording in an audio encoding space; and
performing an iterative transcription process on the one or more encoding vectors, to generate a token sequence representing a transcription of the recording,
wherein each iteration of the iterative transcription process comprises:
obtaining a current version of the token sequence;
inferring an ML-based multilayered decoder on (i) the one or more encoding vectors and (ii) the current version of the token sequence, to produce a first decoding vector, representing the audio data element in a latent transcription token space;
based on the first decoding vector, predicting a candidate token set comprising a plurality of K candidate tokens, each representing a transcription of a respective word in the recording; and
appending two or more candidate tokens of the candidate token set to the current version of the token sequence, thereby updating the token sequence for a subsequent iteration.

2. The method of claim 1, further comprising:
for each candidate token of the candidate token set, evaluating a confidence score, representing a probability of that candidate token correctly representing a transcription of the respective word; and
choosing the two or more candidate tokens from the plurality of K tokens, based on the evaluated confidence scores.

3. The method of claim 1, further comprising obtaining an ML-based projection module, configured to:
given an incident decoding vector, calculate a plurality of token probabilities, each representing a probability of utterance of a corresponding word in the speech recording; and
select a candidate token based on the calculated plurality of token probabilities.

4. The method of claim 3, wherein the ML-based multilayered decoder comprises a serially-ordered stack of first decoding blocks, and wherein the method further comprises:
obtaining the first decoding vector from a final decoding block of the stack of first decoding blocks; and
inferring the ML-based projection module on the first decoding vector, to select a first candidate token of the plurality of K candidate tokens.

5. The method of claim 4, further comprising:
applying (K−1) parallel ML-based heads on the first decoding vector, to obtain (K−1) corresponding latent vectors; and
inferring the ML-based projection module on each of the (K−1) latent vectors, to select (K−1) corresponding, second candidate tokens of the plurality of K candidate tokens,
wherein the first candidate token and the (K−1) second candidate tokens are selected within a single iteration of the iterative transcription process.

6. The method of claim 5, further comprising:
receiving a first training dataset comprising one or more first encoding vectors, representing a first recording of speech in the audio encoding space;
receiving one or more first token labels, each associating a specific encoding vector of the first training dataset with at least one corresponding word in the first recording of speech; and
using the one or more first token labels as supervisory data, to train the ML-based multilayered decoder and the ML-based projection module, so as to select individual candidate tokens, based on corresponding first encoding vectors of the first training dataset.

7. The method of claim 6, further comprising:
receiving a second training dataset, comprising one or more second encoding vectors representing a second recording of speech in the audio encoding space;
inferring the ML-based multilayered decoder and the ML-based projection module on the one or more second encoding vectors, to obtain a sequence of annotation tokens, representing transcription of the second recording; and
using the sequence of annotation tokens as self-supervisory data, to train at least one head of the (K−1) parallel ML-based heads, so as to generate latent vectors that pertain to at least one second token of the (K−1) second tokens, based on the one or more second encoding vectors.

8. The method of claim 4 further comprising:
inferring the multilayered decoder on (i) the one or more encoding vectors and (ii) a first subset of the token sequence, to generate one or more first latent vectors of one or more respective, first tokens of the candidate token set;
based on the one or more first latent vectors, calculating a first plurality of token probabilities, representing probability of appearance of respective words in the speech recording;
inferring the multilayered decoder on (i) the one or more encoding vectors and (ii) a second subset of the token sequence, to generate one or more second latent vectors of one or more respective, second tokens of the candidate token set;
based on the one or more second latent vectors, calculating a second plurality of token probabilities, representing probability of appearance of respective words in the speech recording; and
adjusting the token sequence based on the first and second pluralities of token probabilities.

9. A system for speech transcription, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive an audio data element, representing a recording of speech;
apply a machine-learning (ML) based encoder module on the audio data element, to obtain one or more encoding vectors, representing said recording in an audio encoding space; and
perform an iterative transcription process on the one or more encoding vectors, to generate a token sequence representing a transcription of the recording,
wherein at each iteration of the iterative transcription process, the at least one processor is further configured to:
obtain a current version of the token sequence;
infer an ML-based multilayered decoder on (i) the one or more encoding vectors and (ii) the current version of the token sequence, to produce a first decoding vector, representing the audio data element in a latent transcription token space;
based on the first decoding vector, predict a candidate token set comprising a plurality of K candidate tokens, each representing a transcription of a respective word in the recording; and
append two or more candidate tokens of the candidate token set to the current version of the token sequence, thereby updating the token sequence for a subsequent iteration.

10. The system of claim 9, wherein the at least one processor is further configured to:
for each candidate token of the candidate token set, evaluate a confidence score, representing a probability of that candidate token correctly representing a transcription of the respective word; and
choose the two or more candidate tokens from the plurality of K tokens, based on the evaluated confidence scores.

11. The system of claim 9, wherein the at least one processor is further configured to obtain an ML-based projection module, configured to:
given an incident decoding vector, calculate a plurality of token probabilities, each representing a probability of utterance of a corresponding word in the speech recording; and
select a candidate token based on the calculated plurality of token probabilities.

12. The system of claim 11, wherein the ML-based multilayered decoder comprises a serially-ordered stack of first decoding blocks, and wherein the at least one processor is further configured to:
obtain the first decoding vector from a final decoding block of the stack of first decoding blocks; and
infer the ML-based projection module on the first decoding vector, to select a first candidate token of the plurality of K candidate tokens.

13. The system of claim 12, wherein the at least one processor is further configured to:
apply (K−1) parallel ML-based heads on the first decoding vector, to obtain (K−1) corresponding latent vectors; and
infer the ML-based projection module on each of the (K−1) latent vectors, to select (K−1) corresponding, second candidate tokens of the plurality of K candidate tokens,
wherein the first candidate token and the (K−1) second candidate tokens are selected within a single iteration of the iterative transcription process.

14. The system of claim 13, wherein the at least one processor is further configured to:
receive a first training dataset comprising one or more first encoding vectors, representing a first recording of speech in the audio encoding space;
receive one or more first token labels, each associating a specific encoding vector of the first training dataset with at least one corresponding word in the first recording of speech; and
use the one or more first token labels as supervisory data, to train the ML-based multilayered decoder and the ML-based projection module, so as to select individual candidate tokens, based on corresponding first encoding vectors of the first training dataset.

15. The system of claim 14, wherein the at least one processor is further configured to:
receive a second training dataset, comprising one or more second encoding vectors representing a second recording of speech in the audio encoding space;
infer the ML-based multilayered decoder and the ML-based projection module on the one or more second encoding vectors, to obtain a sequence of annotation tokens, representing transcription of the second recording; and
use the sequence of annotation tokens as self-supervisory data, to train at least one head of the (K−1) parallel ML-based heads, so as to generate latent vectors that pertain to at least one second token of the (K−1) second tokens, based on the one or more second encoding vectors.

16. The system of claim 12, wherein the at least one processor is further configured to:
infer the multilayered decoder on (i) the one or more encoding vectors and (ii) a first subset of the token sequence, to generate one or more first latent vectors of one or more respective, first tokens of the candidate token set;
based on the one or more first latent vectors, calculate a first plurality of token probabilities, representing probability of appearance of respective words in the speech recording;
infer the multilayered decoder on (i) the one or more encoding vectors and (ii) a second subset of the token sequence, to generate one or more second latent vectors of one or more respective, second tokens of the candidate token set;
based on the one or more second latent vectors, calculate a second plurality of token probabilities, representing probability of appearance of respective words in the speech recording; and
adjust the token sequence based on the first and second pluralities of token probabilities.
